(19) United States
(12) Patent Application Publication
(10) Pub. No.: US 2006/0184401 A1
(43) Pub. Date: Aug. 17, 2006

(54) System and method for resource and cost planning of an IT migration

(75) Inventors: Carol DelGaudio, Williston, VT (US); Anne M. Henderson, Essex Junction, VT (US); Scott D. Hicks, Underhill Center, VT (US); James A. Martin JR., Endicott, NY (US); Diane C. Rauch, Williston, VT (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/058,019

(22) Filed: Feb. 15, 2005

(51) Int. Cl. G06F 9/44

(52) U.S. Cl. 705/7

(57) ABSTRACT

A system, method and program product for managing an information technology (IT) migration. A system is disclosed that includes: a database of inventory data records, wherein each inventory data record includes a set of migration parameters for a system to be migrated; a set of estimation tables that provide migration requirements for different sets of migration parameters; and a staffing system that estimates staffing requirements for the IT migration based on the inventory data records and set of estimation tables.

### BACKGROUND OF THE INVENTION

1. Technical Field

The present invention relates generally to managing an information technology (IT) migration, and more specifically relates to a system and method for providing a dynamic tool for planning labor resources, hardware resources and general costs for an IT migration project.

2. Related Art

In large organizations, migrating information technology (IT) from one system to another (e.g., token ring to Ethernet) requires a tremendous amount of oversight and management. Determining and managing labor resources and costs represents a significant challenge given the large numbers of people, devices, network resources, and environmental conditions that are involved. Careful planning is therefore critical to the success of an IT migration project. Once the project is underway, delays or problems with the migration can be very costly in terms of wasted time, money and staff resources.

One of large challenges in such a project involves planning and managing staffing requirements, as the migration will require many different tasks of varying skill. In order to successfully determine staffing requirements, various parameters must be quantified, such as: which devices will be migrated; which individuals will be affected; where are those individuals located; what network ports will be converted; who is responsible for supporting the device; what environment issues exist, such as wall ports being blocked by heavy furniture; what devices are executing critical operations that cannot be interrupted, etc. With this information a plan can put in place for allocating and budgeting staffing requirements.

Unfortunately, in large scale migrations, parameters and requirements can change on a day-to-day basis. For instance, delays may occur, employees may leave or be hired, information gathered for the migration may be incorrect, etc. Accordingly, a tool is required that would allow staffing needs to be determined, budgeted and managed throughout the lifecycle of the IT migration project.

### SUMMARY OF THE INVENTION

The present invention addresses the above-mentioned problems, as well as others, by providing systems and methods that can be used by IT migration project managers to perform staffing and budget planning activities throughout the lifecycle of an IT migration project. An initial electronic inventory database is built to estimate and baseline initial staffing levels. Then, based on actual migration data records, estimates can be refined and changed to provide a dynamic, on demand, staffing tool.

In a first aspect, the invention provides a computer system having a system for managing an information technology (IT) migration, comprising: a database of inventory data records, wherein each inventory data record includes a set of migration parameters for a system to be migrated; a set of estimation tables that provide migration requirements for different sets of migration parameters; and a staffing system that estimates staffing requirements for the IT migration based on the inventory data records and set of estimation tables.

In a second aspect, the invention provides a program product stored on a computer readable medium for managing an information technology (IT) migration, comprising: program code configured for accessing a database of inventory data records, wherein each inventory data record includes a set of migration parameters for a system to be migrated; program code configured for accessing a set of estimation tables that provide migration requirements for different sets of migration parameters; and program code configured for estimating staffing requirements for the IT migration based on the inventory data records and set of estimation tables.

In a third aspect, the invention provides a method for managing an information technology (IT) migration, comprising: gathering inventory data of systems to be migrated into an inventory database, wherein the inventory data for each system includes a set of migration parameters; providing a set of estimation tables that determine migration requirements for different sets of migration parameters; and estimating staffing requirements for the IT migration based on the inventory data and estimation tables.

In a fourth aspect, the invention provides a method for deploying an application for managing an information technology (IT) migration, comprising: providing a computer infrastructure being operable to: gather inventory data of systems to be migrated into an inventory database, wherein the inventory data for each system includes a set of migration parameters; provide a set of estimation tables that determine migration requirements for different sets of migration parameters; and estimate staffing requirements for the IT migration based on the inventory data and estimation tables.

In a fifth aspect, the invention provides a computer software embodied in a propagated signal for managing an information technology (IT) migration, the computer software comprising instructions to cause a computer to perform the following functions: gather inventory data of systems to be migrated into an inventory database, wherein the inventory data for each system includes a set of migration parameters; provide a set of estimation tables that determine migration requirements for different sets of migration parameters; and estimate staffing requirements for the IT migration based on the inventory data and estimation tables.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having an IT migration management system in accordance with the present invention.

FIG. 2 depicts an illustrative user interface showing inventory data in accordance with the present invention.

FIG. 3 depicts a flow chart showing a method for managing an IT migration in accordance with the present invention.

### DETAILED DESCRIPTION OF THE INVENTION

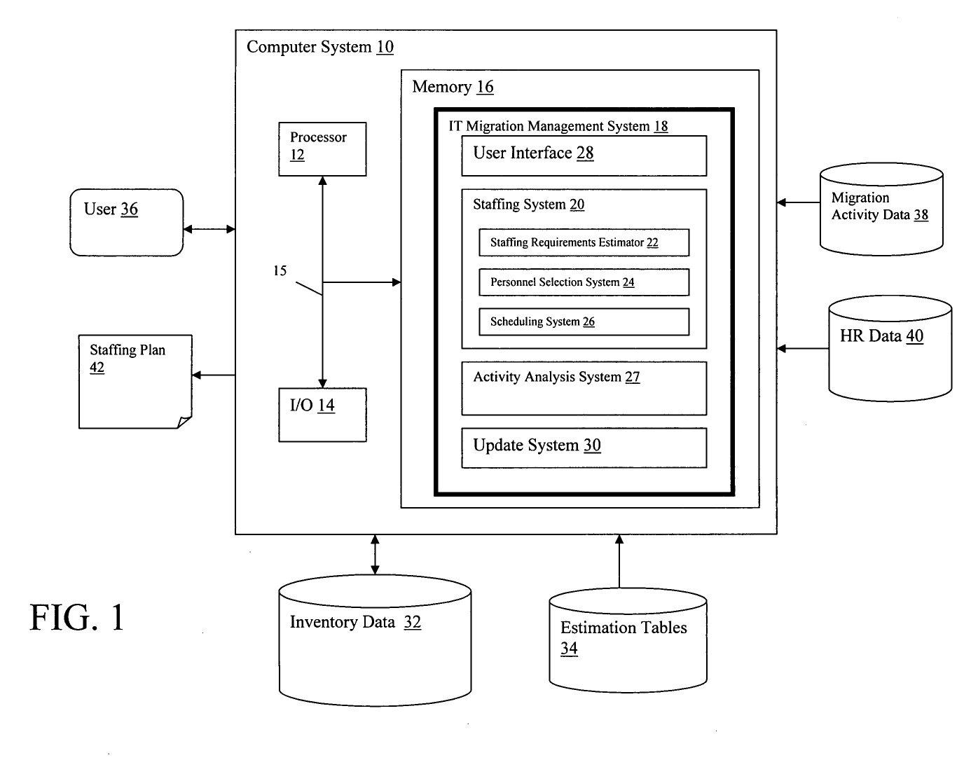

Referring now to the drawings, FIG. 1 depicts a computer system 10 capable of implementing an IT migration management system 18 that can be utilized to generate a staffing plan 42 for a user 36 managing an IT migration. It should be understood that the IT migration management system 18 may be used to manage any and all systems and machines (e.g., computers, printers, software, devices, etc.) involved in a migration. Moreover, it should be understood that the staffing plan 42 may include any relevant planning information related to an IT migration, including labor requirements, hardware resources, software resources, associated costs, etc. Computer system 10 may comprise, e.g., a desktop, a laptop, a workstation, etc. Moreover, computer system 10 could be implemented as part of a client and/or a server. Computer system 10 generally includes a processor 12, memory 16, bus 15, input/output interfaces (I/O) 14, and various external devices and resources, such as external storage. The processing unit 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External resources may comprise any known type of external device, including: storage, a display, speakers, a hand-held device, keyboard, mouse, voice recognition system, speech output system, printer, facsimile, pager, etc. Bus 15 may be included to provide a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Data utilized by computer system 10 may be stored in any type of storage system (e.g., a relational database, flat file, etc.) and may include one or more storage devices, such as RAM, ROM, a magnetic disk drive and/or an optical disk drive. Data storage can also be distributed across, for example, a local area network (LAN), wide area network (WAN) or a storage area network (SAN) (not shown).

Access to computer system 10 may also be implemented over any type of network such as the Internet, a local area network (LAN), a wide area network (WAN), a virtual private network (VPN), etc. Communication may occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, communication could occur in a client-server or server-server environment.

IT migration management system 18 includes: a user interface 28 that allows user 26 (e.g., a migration project manager) to interact with the IT migration management system 18; a staffing system 20 having various capabilities that allows user 26 to manage staffing based on inventory data 32; an activity analysis system 27 that analyzes ongoing migration activity data 38 in order to create and refine estimation tables 34; and an update system 30 that updates the inventory data 32 based on human resource (HR) data 40 and information in the estimation tables 34. It should understood that the term “estimation table” as used herein, which provides estimated requirements for different sets of migration parameters, can be implemented in any manner i.e., a migration table may be implemented as a data object, a program, a flat file, a database, etc.

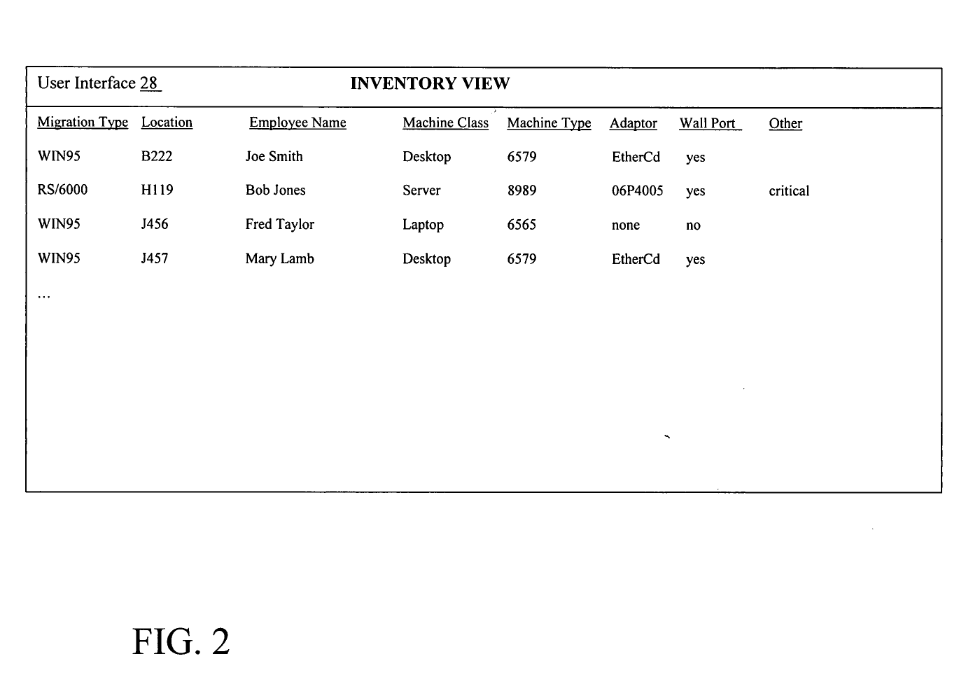

The inventory data 32 may include any information relevant to the migration, such as affected machines, their operating systems, existence of necessary devices such network cards, the affected people, location, criticality of the system, etc. FIG. 2 depicts an illustrative view of several records of inventory data 22 which require migration from token ring to Ethernet. Each record provides configuration or migration parameters about a machine that must be migrated. For instance, as shown in FIG. 2, each machine includes a migration type (i.e., operation system), a location of the machine, an employee, a machine class and type, any adaptors required for the migration, availability of a wall port, and other. Migration parameters may be gathered and stored in any manner.

Once inventory data 32 is gathered, staffing system 20 can be implemented to generate a staffing plan 42. Staffing system 20 includes a staffing requirements estimator 22 that estimates staffing requirements for the inventory data based on a set of estimation tables 34. Staffing requirements may be sorted and presented by the user interface 28 in any manner, e.g., by machine type, by project phase, by date, by project, etc.

Estimation tables 34 are provided to estimate what it will take to migrate a machine based on a machine's migration parameters. Thus, for each inventory record, an estimation table is located that has the same (or similar) migration parameters. From the estimation table, all of the migration requirements for the inventory record can be obtained, e.g., any hardware required and its cost, the types and amount of labor required, labor costs, etc. An illustrative estimation table may be implanted as follows:

MIGRATION TABLE

Migration Parameters:
WIN95/desktop/no adaptor card installed/
Migration Requirements:
Adaptor cost: $45
Cable cost: $3
Connector cost: $1
Inventory labor: 0.5hr
Migration labor: 2.0hr
Post-Migration labor: 0.5
Labor cost per hour: $50

It should be understood that the number, presentation, format and complexity of the migration tables may vary, and the above is provided for illustrative purposes only. Once a matching estimation table is located for a record, the migration requirements can be plugged into the staffing system 20 to determine staffing requirements. Estimations can be calculated in any manner. For instance, estimations could be done manually with a spreadsheet, or be automated through the use of configurable criteria in a database. For example, staffing estimates and costs could be loaded into a configuration document that stores the estimation tables 34.

By analyzing the inventory data 32, staffing system 20 can estimate labor resources, labor costs, and hardware expenses for the entire migration project, or a portion thereof. Estimates can be displayed by the user interface in any manner at any granularity, e.g., by total projected time to complete the project, by cost, etc. Scheduling system 26 provides a mechanism by which the user 36 can schedule individual machine migrations. Personnel selection system 24 allows the user 36 to assign specific individuals to perform machine migrations based on information collected from human resource (HR) data 40. For instance, a low skilled IT worker can be scheduled to perform 16 prepping operations each day (e.g., physically locating the machines and ports, and opening their cases); a higher skilled IT worked can then be scheduled on the same day to install and test network adaptor cards on those machines.

As noted above, as a large scale IT migration project progresses, any number of changes may effect the management of the migration during the project lifecycle. For instance, IT employees may leave/join the organization; additional machines requiring migration may be located; inventory records may be updated; migrations may be completed or partially completed, early, on-time, or late; migrations may be rescheduled, etc. To account for this dynamic behavior, IT migration management system 18 includes an activity analysis system 27 that analyzes ongoing migration activity data 38. The results of the analysis may be used to refine the estimation tables 34. Thus for example, if based on existing migration activity data, it is determined that a labor task typically takes 1.5 hours instead of 1.0 hours, the relevant estimation tables 34 can be updated to reflect this requirement by the activity analysis system 27.

An update system 30 may also be periodically run (e.g., daily) in order to update the staffing plan 42 based on changes to HR data 40, migration progress made to date, any revised estimations based on changes to the estimation tables, etc. For example, an employee scheduled to handle various migration tasks may have left the organization. Update system 30 can be run such that these changes are incorporated by the staffing system 20, and a new staffing plan 42 can be generated.

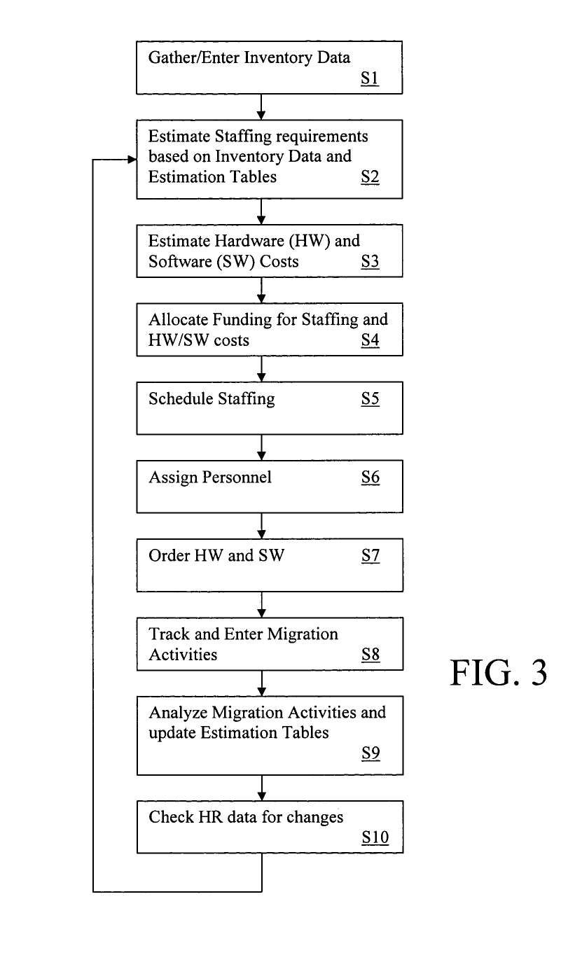

FIG. 3 depicts a flow chart showing an illustrative embodiment of the invention. In the first step at S1, inventory data 32 is gathered and entered into an inventory database. Inventory data 32 may be gathered using any method, e.g., physical inspection, email questionnaires, etc. Next, at step S2, staffing requirements are estimated based on inventory data 32 and estimation tables 34. At steps S3 and S4, hardware and software costs are estimated and funding for staffing and hardware and software is allocated, respectively. At steps S5 and S6, migration tasks are scheduled and personnel are assigned to perform tasks, respectively. At step S7, hardware and software are ordered. At step S8, ongoing migration activities are tracked and captured. At step S9, migration activities are analyzed and estimation tables 32 are updated. At step S10, HR data 40 is checked for any changes. Next, control is passed back to step S2, where staffing requirements are recalculated, staffing is rescheduled, and personnel are reassigned as necessary.

Using different views provided by the user interface 28, resource requirements can be planned. For example, required hardware installations can be estimated and planned for each phase of the migration project; the duration of individual migrations can be estimated based upon any number of migration parameters; the skill sets required for each task require for a machine migration can be identified and assigned to different personnel; specific people in the organization who need to be involved with a machine migration can be identified and assigned to any critical tasks; migration appointments can be scheduled in advance with the affected employees; coordination among different staff, e.g., network technicians and migration technicians can be planned and scheduled; relative staffing levels between different skill groups can be planned (e.g., one network technician per three migration technicians) based upon the machine types in the inventory database; machines with time critical applications can be highlighted for special arrangements; etc.

It should be appreciated that the teachings of the present invention could be offered as a business method on a subscription or fee basis. For example, a computer system 10 comprising an IT migration management system 18 could be created, maintained and/or deployed by a service provider that offers the functions described herein for customers. That is, a service provider could provide an on-line mechanism for generating staffing plans as described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A computer system having a system for managing an information technology (IT) migration, comprising:
a database of inventory data records, wherein each inventory data record includes a set of migration parameters for a system to be migrated;
a set of estimation tables that provide migration requirements for different sets of migration parameters; and
a staffing system that estimates staffing requirements for the IT migration based on the inventory data records and set of estimation tables.

2. The computer system of claim 1, wherein the staffing system further includes a scheduling system for scheduling the estimated staffing requirements.

3. The computer system of claim 2, wherein the staffing system further includes a personnel selection system for assigning migration tasks to selected personnel.

4. The computer system of claim 3, further comprising a system for analyzing human resource data in order to confirm availability of the selected personnel.

5. The computer system of claim 1, wherein the staffing system further estimates labor costs.

6. The computer system of claim 1, wherein the staffing system further estimates hardware requirements and related costs.

7. The computer system of claim 1, further comprising a system for analyzing ongoing migration activity data and refining the migration requirements in the set of estimation tables.

8. A program product stored on a computer readable medium for managing an information technology (IT) migration, comprising:
program code configured for accessing a database of inventory data records, wherein each inventory data record includes a set of migration parameters for a system to be migrated;
program code configured for accessing a set of estimation tables that provide migration requirements for different sets of migration parameters; and
program code configured for estimating staffing requirements for the IT migration based on the inventory data records and set of estimation tables.

9. The program product of claim 8, further comprising program code configured for scheduling the estimated staffing requirements.

10. The program product of claim 9, further comprising program code configured for assigning migration tasks to selected personnel.

11. The program product of claim 10, further comprising program code configured for analyzing human resource data in order to confirm availability of the selected personnel.

12. The program product of claim 8, further comprising program code configured for estimating labor costs.

13. The program product of claim 8, further comprising program code configured for estimating hardware requirements and related costs.

14. The program product of claim 8, further comprising further comprising program code configured for analyzing ongoing migration activity data and refining the migration requirements in the set of estimation tables.

15. A method for managing an information technology (IT) migration, comprising:
gathering inventory data of systems to be migrated into an inventory database, wherein the inventory data for each system includes a set of migration parameters;
providing a set of estimation tables that determine migration requirements for different sets of migration parameters; and
estimating staffing requirements for the IT migration based on the inventory data and estimation tables.

16. The method of claim 15, comprising the further step of scheduling the estimated staffing requirements.

17. The method of claim 16, comprising the further step of assigning migration tasks to selected personnel.

18. The method of claim 17, comprising the further step of analyzing human resource data in order to confirm availability of the selected personnel.

19. The method of claim 15, comprising the further step of estimating labor costs for the IT migration.

20. The method of claim 15, comprising the further step of estimating hardware requirements and related costs for the IT migration.

21. The method of claim 15, comprising the further step of analyzing ongoing migration activity data and refining the migration requirements in the set of estimation tables.

22. A method for deploying an application for managing an information technology (IT) migration, comprising:
providing a computer infrastructure being operable to:
gather inventory data of systems to be migrated into an inventory database, wherein the inventory data for each system includes a set of migration parameters;
provide a set of estimation tables that determine migration requirements for different sets of migration parameters; and
estimate staffing requirements for the IT migration based on the inventory data and estimation tables.

23. Computer software embodied in a propagated signal for managing an information technology (IT) migration, the computer software comprising instructions to cause a computer to perform the following functions:
gather inventory data of systems to be migrated into an inventory database, wherein the inventory data for each system includes a set of migration parameters;
provide a set of estimation tables that determine migration requirements for different sets of migration parameters; and
estimate staffing requirements for the IT migration based on the inventory data and estimation tables.
